(19) United States
(12) Patent Application Publication
(10) Pub. No.: US 2019/0338124 A1
(43) Pub. Date: Nov. 7, 2019

(54) HIGH FLOW POLYETHERIMIDE COMPOSITIONS, AND ARTICLES MADE THEREFROM

(71) Applicant: SABIC GLOBAL TECHNOLOGIES B.V., BERGEN OP ZOOM (NL)

(72) Inventors: SIJUN LI, SHANGHAI (CN); LIANG SHEN, SHANGHAI (CN)

(21) Appl. No.: 16/470,706

(22) PCT Filed: Jan. 12, 2018
(86) PCT No.: PCT/IB2018/050213

§ 371 Date: Jun. 18, 2019

Related U.S. Application Data
(60) Provisional application No. 62/445,788, filed on Jan. 13, 2017.

(51) Int. Cl. C08L 79/08; C08J 5/04

(52) U.S. Cl. CPC C08L 79/08; C08J 5/043; C08L 2205/12; C08J 2471/00; C08L 2205/025; C08J 2379/08; C08J 2479/08; C08L 2205/06

(57) ABSTRACT

A reinforced polyetherimide composition includes 50 to 99.9 weight percent of a polymer composition comprising a polyetherimide having a weight average molecular weight of 5,000 to 80,000 Daltons; 10 to 40 weight percent of a reinforcing filler; 0.1 to 10 weight percent of flow promoter, wherein the flow promoter comprises an aromatic phosphate, a phosphazene, or a combination comprising at least one of the foregoing; 0 to 20 weight percent of a liquid crystalline polymer; wherein weight percent is based on the total weight of the reinforced polyetherimide composition; and wherein the composition has a melt flow rate (MFR) that is at least 10% higher than that of the same reinforced polyetherimide composition without the flow promoter, and a capillary melt viscosity that is at least 10% lower than that of the same reinforced polyetherimide composition without the flow promoter.

### BACKGROUND

Polyimides, specifically polyetherimides (PEI) are high performance polymers having high strength, heat resistance, and modulus, and broad chemical resistance. Polyetherimides are widely used in applications including automotive, telecommunications, aerospace, electrical/electronics, transportation, food service, and healthcare. Filler reinforced polyetherimides have been used in the electronic market due to outstanding performance such as high heat, high modulus, good dimensional stability and broad chemical resistance. The miniaturization trend in the electronic industry, however, has created a requirement for processability to facilitate thin wall applications in this field. Current filled polyetherimide resins can exhibit low flow-ability for thin wall molding, i.e., moldings having a thickness that is less than 0.5 mm.

Accordingly, there remains a continuing need for improved reinforced, e.g., glass fiber (GF) filled, polyetherimide composites with a flow promoter component to achieve thin wall part molding for electronic applications, for example.

### BRIEF DESCRIPTION

A reinforced polyetherimide composition comprises: 50 to 99.9 weight percent of a polymer composition comprising a polyetherimide having a weight average molecular weight of 5,000 to 80,000 Daltons; 10 to 40 weight percent of a reinforcing filler; 0.1 to 10 weight percent of flow promoter, wherein the flow promoter comprises an aromatic phosphate, a phosphazene, or a combination comprising at least one of the foregoing;

0 to 20 weight percent of a liquid crystalline polymer; wherein weight percent is based on the total weight of the reinforced polyetherimide composition; and wherein the reinforced polyetherimide composition has a melt flow rate (MFR), measured according to ASTM D1238 (2015) at 337° C. under a 6.7 kilogram-force (kgf) load, that is at least 10% higher than that of the same reinforced polyetherimide composition without the flow promoter, and a capillary melt viscosity, measured according to ASTM D3835 (2015) at a shear rate of 5000 l/s and a temperature of 380° C., that is at least 10% lower than that of the same reinforced polyetherimide composition without the flow promoter.

An article comprising the reinforced polyetherimide composition represents another aspect of the disclosure.

The above described and other features are exemplified by the following detailed description.

### DETAILED DESCRIPTION

Described herein are reinforced polyetherimide compositions comprising a polymer composition that includes a polyetherimide, a reinforcing filler, and a flow promoter, the flow promoter comprising an aromatic phosphate, a phosphazene, or a combination comprising at least one of the foregoing. The reinforced polyetherimide compositions optionally further comprise a liquid crystalline polymer. The inventors hereof have discovered that the use of a flow promoter comprising an aromatic phosphate, a phosphazene, or a combination comprising at least one of the foregoing, provides reinforced polyetherimide compositions that have excellent melt flow properties, as well as excellent mechanical properties. The reinforced polyetherimide compositions are particularly useful for electronics applications.

The reinforced polyetherimide composition comprises a polymer composition including a polyetherimide, such as a polyetherimide having a weight average molecular weight of 5,000 to 80,000 Daltons; a reinforcing filler; a flow promoter, wherein the flow promoter comprises an aromatic phosphate, a phosphazene, or a combination comprising at least one of the foregoing; and optionally a liquid crystalline polymer; wherein weight percent is based on the total weight of the composition.

Polyetherimides comprise more than 1, for example 2 to 1000, or 5 to 500, or 10 to 100 structural units of formula (1)

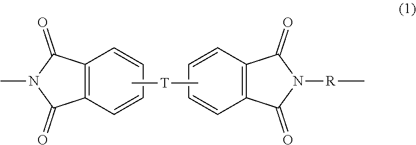

wherein each R is independently the same or different, and is a substituted or unsubstituted divalent organic group, such as a substituted or unsubstituted C₆₋₂₀ aromatic hydrocarbon group, a substituted or unsubstituted straight or branched chain C₄₋₂₀ alkylene group, a substituted or unsubstituted C₃₋₈ cycloalkylene group, in particular a halogenated derivative of any of the foregoing. In some embodiments R is divalent group of one or more of the following formulas (2)

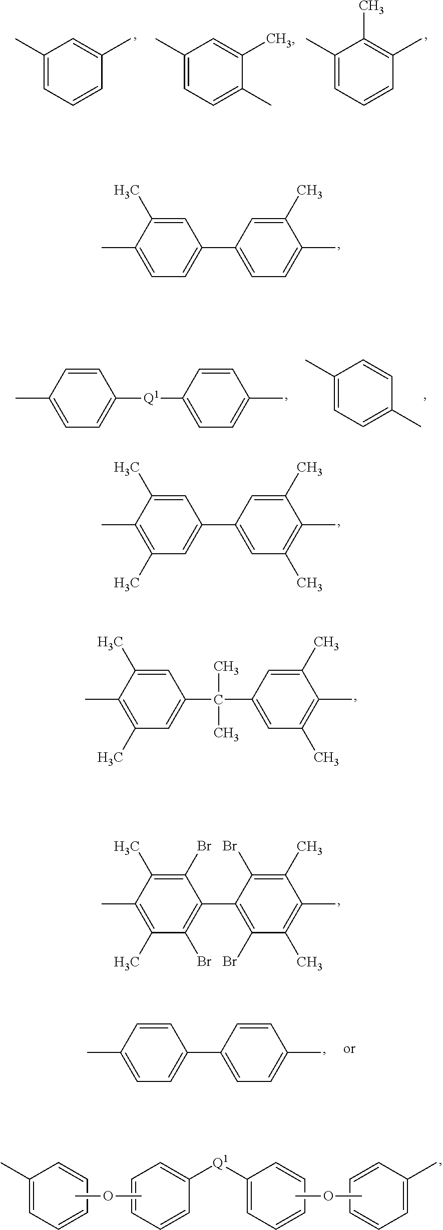

wherein Q¹ is —O—, —S—, —C(O)—, —SO₂—, —SO—, —P(R^{a})(═O)— wherein R^{a} is a C₁₋₈ alkyl or C₆₋₁₂ aryl, —C_{y}H_{2y}— wherein y is an integer from 1 to 5 or a halogenated derivative comprising at least one of the foregoing (which includes perfluoroalkylene groups), or —(C₆H₁₀)_{z}— wherein z is an integer from 1 to 4. In some embodiments R is m-phenylene, p-phenylene, or a diarylene sulfone, in particular bis(4,4′-phenylene)sulfone, bis(3,4′-phenylene)sulfone, bis(3,3′-phenylene)sulfone, or a combination comprising at least one of the foregoing. In some embodiments, at least 10 mole percent or at least 50 mole percent of the R groups contain sulfone groups, and in other embodiments no R groups contain sulfone groups.

Further in formula (1), T is —O— or a group of the formula —O—Z—O— wherein the divalent bonds of the —O— or the —O—Z—O— group are in the 3,3′, 3,4′, 4,3′, or the 4,4′ positions, and Z is an aromatic C₆₋₂₄ monocyclic or polycyclic moiety optionally substituted with 1 to 6 C₁₋₈ alkyl groups, 1 to 8 halogen atoms, or a combination comprising at least one of the foregoing, provided that the valence of Z is not exceeded. Exemplary groups Z include groups of formula (3)

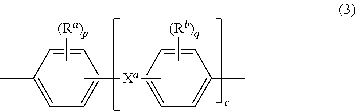

wherein R^{a} and R^{b} are each independently the same or different, and are a halogen atom or a monovalent C₁₋₆ alkyl group, for example; p and q are each independently integers of 0 to 4; c is 0 to 4; and X^{a} is a bridging group connecting the hydroxy-substituted aromatic groups, where the bridging group and the hydroxy substituent of each C₆ arylene group are disposed ortho, meta, or para (specifically para) to each other on the C₆ arylene group. The bridging group X^{a} can be a single bond, —O—, —S—, —S(O)—, —S(O)₂—, —C(O)—, or a C₁₋₁₈ organic bridging group. The C₁₋₁₈ organic bridging group can be cyclic or acyclic, aromatic or non-aromatic, and can further comprise heteroatoms such as halogens, oxygen, nitrogen, sulfur, silicon, or phosphorous. The C₁₋₁₈ organic group can be disposed such that the C₆ arylene groups connected thereto are each connected to a common alkylidene carbon or to different carbons of the C₁₋₁₈ organic bridging group. A specific example of a group Z is a divalent group of formula (3a)

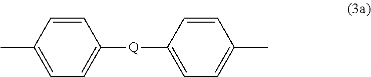

wherein Q is —O—, —S—, —C(O)—, —SO₂—, —SO—, —P(R^{a})(═O)— wherein R^{a} is a C₁₋₈ alkyl or C₆₋₁₂ aryl, or —C_{y}H_{2y}— wherein y is an integer from 1 to 5 or a halogenated derivative comprising at least one of the foregoing (including a perfluoroalkylene group). In a specific embodiment Z is a derived from bisphenol A, such that Q in formula (3a) is 2,2-isopropylidene.

In an embodiment in formula (1), R is m-phenylene, p-phenylene, or a combination comprising at least one of the foregoing, and T is —O—Z—O— wherein Z is a divalent group of formula (3a). Alternatively, R is m-phenylene, p-phenylene, or a combination comprising at least one of the foregoing, and T is —O—Z—O wherein Z is a divalent group of formula (3a) and Q is 2,2-isopropylidene. Alternatively, R is m-phenylene, p-phenylene, or a combination comprising at least one of the foregoing, and T is —O—Z—O wherein Z is a divalent group of formula (3a) and Q is 2,2-isopropylidene. Alternatively, the polyetherimide can be a copolymer comprising additional structural polyetherimide units of formula (1) wherein at least 50 mole percent (mol %) of the R groups are bis(4,4′-phenylene)sulfone, bis(3,4′-phenylene)sulfone, bis(3,3′-phenylene)sulfone, or a combination comprising at least one of the foregoing and the remaining R groups are p-phenylene, m-phenylene or a combination comprising at least one of the foregoing; and Z is 2,2-(4-phenylene)isopropylidene, i.e., a bisphenol A moiety.

In some embodiments, the polyetherimide is a copolymer that optionally comprises additional structural imide units that are not polyetherimide units, for example imide units of formula (4)

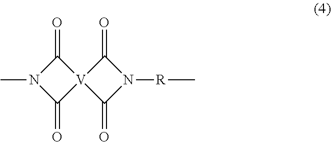

wherein R is as described in formula (1) and each V is the same or different, and is a substituted or unsubstituted C₆₋₂₀ aromatic hydrocarbon group, for example a tetravalent linker of the formulas

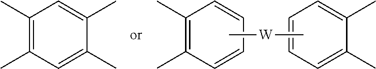

wherein W is a single bond, —O—, —S—, —C(O)—, —SO₂—, —SO—, —P(R^{a})(═O)— wherein R^{a} is a C₁₋₈ alkyl or C₆₋₁₂ aryl, or —C_{y}H_{2y}— wherein y is an integer from 1 to 5 or a halogenated derivative comprising at least one of the foregoing (which includes perfluoroalkylene groups). These additional structural imide units preferably comprise less than 20 mol % of the total number of units, and more preferably can be present in amounts of 0 to 10 mol % of the total number of units, or 0 to 5 mol % of the total number of units, or 0 to 2 mole % of the total number of units. In some embodiments, no additional imide units are present in the polyetherimide.

The polyetherimide can be prepared by any of the methods known to those skilled in the art, including the reaction of an aromatic bis(ether anhydride) of formula (5) or a chemical equivalent comprising at least one of the foregoing, with an organic diamine of formula (6)

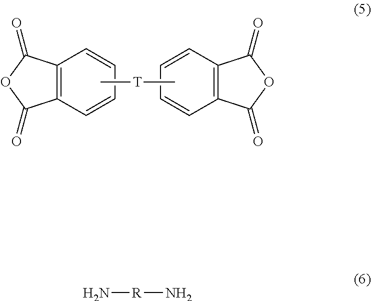

wherein T and R are defined as described above. Copolymers of the polyetherimides can be manufactured using a combination of an aromatic bis(ether anhydride) of formula (5) and an additional bis(anhydride) that is not a bis(ether anhydride), for example pyromellitic dianhydride or bis(3,4-dicarboxyphenyl) sulfone dianhydride.

Illustrative examples of aromatic bis(ether anhydride)s include 2,2-bis[4-(3,4-dicarboxyphenoxy)phenyl]propane dianhydride (also known as bisphenol A dianhydride or BPADA), 3,3-bis[4-(3,4-dicarboxyphenoxy)phenyl]propane dianhydride; 4,4′-bis(3,4-dicarboxyphenoxy)diphenyl ether dianhydride; 4,4′-bis(3,4-dicarboxyphenoxy)diphenyl sulfide dianhydride; 4,4′-bis(3,4-dicarboxyphenoxy)benzophenone dianhydride; 4,4′-bis(3,4-dicarboxyphenoxy)diphenyl sulfone dianhydride; 4,4′-bis(2,3-dicarboxyphenoxy)diphenyl ether dianhydride; 4,4′-bis(2,3-dicarboxyphenoxy)diphenyl sulfide dianhydride; 4,4′-bis(2,3-dicarboxyphenoxy)benzophenone dianhydride; 4,4′-bis(2,3-dicarboxyphenoxy)diphenyl sulfone dianhydride; 4-(2,3-dicarboxyphenoxy)-4′-(3,4-dicarboxyphenoxy)diphenyl-2,2-propane dianhydride; 4-(2,3-dicarboxyphenoxy)-4′-(3,4-dicarboxyphenoxy)diphenyl ether dianhydride; 4-(2,3-dicarboxyphenoxy)-4′-(3,4-dicarboxyphenoxy)diphenyl sulfide dianhydride; 4-(2,3-dicarboxyphenoxy)-4′-(3,4-dicarboxyphenoxy)benzophenone dianhydride; 4,4′-(hexafluoroisopropylidene)diphthalic anhydride; and 4-(2,3-dicarboxyphenoxy)-4′-(3,4-dicarboxyphenoxy)diphenyl sulfone dianhydride. A combination of different aromatic bis(ether anhydride)s can be used.

Examples of organic diamines include 1,4-butane diamine, 1,5-pentanediamine, 1,6-hexanediamine, 1,7-heptanediamine, 1,8-octanediamine, 1,9-nonanediamine, 1,10-decanediamine, 1,12-dodecanediamine, 1,18-octadecanediamine, 3-methylheptamethylenediamine, 4,4-dimethylheptamethylenediamine, 4-methylnonamethylenediamine, 5-methylnonamethylenediamine, 2,5-dimethylhexamethylenediamine, 2,5-dimethylheptamethylenediamine, 2, 2-dimethylpropylenediamine, N-methyl-bis (3-aminopropyl) amine, 3-methoxyhexamethylenediamine, 1,2-bis(3-aminopropoxy) ethane, bis(3-aminopropyl) sulfide, 1,4-cyclohexanediamine, bis-(4-aminocyclohexyl) methane, m-phenylenediamine, p-phenylenediamine, 2,4-diaminotoluene, 2,6-diaminotoluene, m-xylylenediamine, p-xylylenediamine, 2-methyl-4,6-diethyl-1,3-phenylene-diamine, 5-methyl-4,6-diethyl-1,3-phenylene-diamine, benzidine, 3,3′-dimethylbenzidine, 3,3′-dimethoxybenzidine, 1,5-diaminonaphthalene, bis(4-aminophenyl) methane, bis(2-chloro-4-amino-3,5-diethylphenyl) methane, bis(4-aminophenyl) propane, 2,4-bis(p-amino-t-butyl) toluene, bis(p-amino-t-butylphenyl) ether, bis(p-methyl-o-aminophenyl) benzene, bis(p-methyl-o-aminopentyl) benzene, 1, 3-diamino-4-isopropylbenzene, bis(4-aminophenyl) sulfide, bis-(4-aminophenyl) sulfone (also known as 4,4′-diaminodiphenyl sulfone (DDS)), and bis(4-aminophenyl) ether. Any regioisomer of the foregoing compounds can be used. C₁₋₄ alkylated or poly(C₁₋₄)alkylated derivatives of any of the foregoing can be used, for example a polymethylated 1,6-hexanediamine. Combinations of these compounds can also be used. In some embodiments the organic diamine is m-phenylenediamine, p-phenylenediamine, 4,4′-diaminodiphenyl sulfone, 3,4′-diaminodiphenyl sulfone, 3,3′-diaminodiphenyl sulfone, or a combination comprising at least one of the foregoing.

The polyetherimide can have a melt index of 0.1 to 10 grams per minute (g/min), as measured by American Society for Testing Materials (ASTM) D1238 at 340 to 370° C., using a 6.7 kilogram (kg) weight. In some embodiments, the polyetherimide has a weight average molecular weight (Mw) of 1,000 to 150,000 grams/mole (Dalton), as measured by gel permeation chromatography, using polystyrene standards. In some embodiments the polyetherimide has an Mw of 10,000 to 80,000 Daltons. Such polyetherimides typically have an intrinsic viscosity greater than 0.2 deciliters per gram (dl/g), or, more specifically, 0.35 to 0.7 dl/g as measured in m-cresol at 25° C.

In an embodiment, the polymer composition comprises 10 to 99 weight percent (wt %) of the polyetherimide and 50 to 1 wt % of a different polymer that is not the same as the polyetherimide, each based on the total weight of the polymer composition. For example, the polymer composition can comprises 30 to 99 wt %, or 40 to 99 wt %, or 50 to 999 wt % of the polyetherimide, and 70 to 1 wt %, or 60 to 1 wt %, or 50 to 1 wt % of the different polymer. In an embodiment, the polymer composition comprises more than 50 wt % of the polyetherimide, for example 60 to 98 wt %, or 70 to 95 wt % of the polyetherimide, and less than 50 wt % of the different polymer, for example 40 to 2 wt % or 30 to 15 weight percent. In some embodiments only the polyetherimide as described above is present.

Exemplary polymer compositions can be wholly polyetherimide-based, for example a polyetherimide with no sulfone-containing units and a poly(etherimide-sulfone); or a polyetherimide with no siloxane-containing units and a poly(siloxane-etherimide). Polyetherimide-sulfones are described above. A poly(siloxane-etherimide) comprises polyetherimide units of formula (1) and siloxane blocks of formula (7)

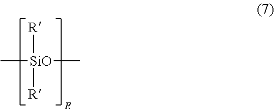

wherein E has an average value of 2 to 100, 2 to 31, 5 to 75, 5 to 60, 5 to 15, or 15 to 40, each R′ is independently a C₁₋₁₃ monovalent hydrocarbyl group, for example methyl or trifluoromethyl group. The relative amount of polysiloxane units and etherimide units in the poly(siloxane-etherimide) depends on the desired properties, and can be, for example 10 to 50 wt %, 10 to 40 wt %, or 20 to 35 wt % polysiloxane units, based on the total weight of the poly(siloxane-etherimide). Examples of specific poly(siloxane-etherimide)s are described in U.S. Pat. Nos. 4,404,350, 4,808,686, and 4,690,997. In an embodiment, the poly(siloxane-etherimide) has units of formula (8)

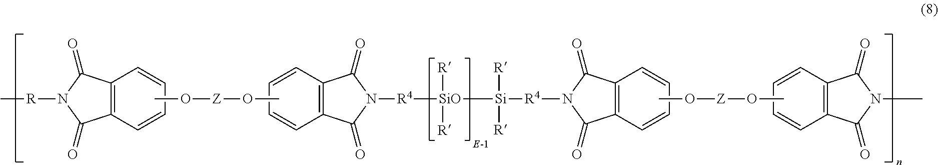

wherein R′ and E of the siloxane are as in formula (7), R and Z of the imide are as in formula (1), R⁴ is as in formula (8), and n is an integer from 5 to 100. In a specific embodiment of the poly(siloxane-etherimide), R of the etherimide is a phenylene, Z is a residue of bisphenol A, R⁴ is n-propylene, E is 2 to 50, 5, to 30, or 10 to 40, n is 5 to 100, and each R′ of the siloxane is methyl.

Alternatively, or in addition, the polymer composition comprises the polyetherimide (or combination of different polyetherimides) and a different type of polymer, for example polyamides, polyamideimides, polyarylene ethers (e.g., poly (2,6-dimethyl-p-phenylene oxide (PPO) and copolymers thereof (PPE)), polyarylene ether ketones (including polyether ether ketones (PEEK), polyether ketone ketones (PEKK), and the like), polyarylene sulfides (e.g., polyphenylene sulfides (PPS)), polyarylene sulfones (including polysulfones (PSU), polyethersulfones (PES), polyphenylene sulfones (PPSU), and the like), polycarbonates (including poly(carbonate-siloxanes, poly(carbonate-ester)s such as poly(carbonate-arylate ester)s, and poly(carbonate-arylate ester-siloxane)s), polyesters (e.g., polyethylene terephthalate (PET), poly(1,4-butylene terephthalate) (PBT), polyethylene naphthalate (PEN), poly(cyclohexylenedimethylene terephthalate) (PCT), glycol-modified polyethylene terephthalate (PETG), and glycol-modified polycyclohexylenedimethylene terephthalate (PCTG)), polyimides, polyphenylenesulfone ureas, polyphthalamides (PPA), or self-reinforced polyphenylene (SRP), and the like. A combination comprising at least one of the foregoing can be used.

In a specific embodiment, the different polymer is a high-temperature polymer, i.e., a polymer having a Tg greater than 180° C. In another specific embodiment, the different polymer forms a miscible blend with the polyetherimide in the reinforced polyetherimide composition. The different polymer need only be miscible in the presence of the other components, for example the reinforcing filler.

The polymer composition can be present in an amount of 50 to 99.9 wt %, for example, preferably 75 to 99.9 wt %, more preferably 90 to 99.9 wt %, most preferably 95 to 99.9 wt %, wherein weight percent is based on the total weight of the reinforced polyetherimide composition.

The reinforced polyetherimide composition comprises a reinforcing filler. Reinforcing fillers can include mica, clay, feldspar, quartz, quartzite, perlite, tripoli, diatomaceous earth, aluminum silicate (mullite), synthetic calcium silicate, fused silica, fumed silica, sand, boron-nitride powder, boron-silicate powder, calcium sulfate, calcium carbonates (such as chalk, limestone, marble, and synthetic precipitated calcium carbonates) talc (including fibrous, modular, needle shaped, and lamellar talc), wollastonite, hollow or solid glass spheres, silicate spheres, aluminosilicate, kaolin, whiskers of silicon carbide, alumina, boron carbide, iron, nickel, or copper, continuous and chopped carbon fibers or glass fibers, molybdenum sulfide, zinc sulfide, barium titanate, barium ferrite, barium sulfate, heavy spar, TiO₂, aluminum oxide, magnesium oxide, particulate or fibrous aluminum, bronze, zinc, copper, or nickel, glass flakes, flaked silicon carbide, flaked aluminum diboride, flaked aluminum, steel flakes, as well as combinations comprising at least one of the foregoing reinforcing fillers. The reinforcing fillers can be coated with a layer of metallic material to facilitate conductivity, or surface treated with silanes to improve adhesion and dispersion with the polymer matrix. In some embodiments, the reinforcing filler can comprise glass fiber, carbon fiber, titanium dioxide, clay, talc, mica, silica, mineral filler, wollastonite, glass spheres, flaked glass, milled glass, carbon black, and combinations comprising at least one of the foregoing. For example, the reinforcing filler can comprise glass fibers.

Useful glass fibers can be formed from any type of known fiberizable glass composition, and include, for example, those prepared from fiberizable glass compositions commonly known as “E-glass,” “C-glass,” “D-glass,” “R-glass,” “S-glass,” as well as E-glass derivatives that are fluorine-free and/or boron-free. Commercially produced glass fibers generally have nominal filament diameters of 4.0 to 35.0 micrometers (μm), and most commonly produced E-glass fibers can have a nominal filament diameter of 9.0 to 30.0 micrometers. For example, glass fibers can have a diameter of 9 to 20 μm, specifically 10 to 15 μm. The filaments can be made by standard processes, for example, by steam or air blowing, flame blowing and mechanical pulling. The filaments for polymer reinforcement can be made by mechanical pulling. A fiber having a non-round cross section can also be used. The glass fibers can be sized or unsized. In a specific embodiment, the reinforcing filler can be an E-glass fiber having a diameter of 5 to 20 micrometers, specifically 9 to 20 μm, and more specifically 10 to 15 μm. The glass fibers can have various cross-sectional shapes, for example, round, trapezoidal, rectangular, square, crescent, bilobal, trilobal, and hexagonal. In an embodiment, the glass can be soda free. Fibrous glass fibers comprising lime-alumino-borosilicate glass, known as “E” glass, can be especially useful. Glass fibers can greatly increase the flexural modulus and strength of the polyetherimide compositions. The glass fibers can be used in the form of chopped strands, having lengths of about ⅛ inch (3 mm) to about ½ inch (13 mm). In some embodiments, rovings can also be used. The glass fiber length in molded articles prepared from compositions comprising the glass fibers can be shorter than the above mentioned lengths, presumably due to fiber fragmentation during compounding of the composition. For example, the length of the glass fibers in a molded article can be less than about 2 millimeters (mm).

The fibers can optionally be treated with various coupling agents to improve adhesion to the polymeric matrix. Examples of coupling agents can include alkoxy silanes and alkoxy zirconates, amino-, epoxy-, amide- and mercapto-functionalized silanes, and organometallic coupling agents, including, for example, titanium- or zirconium-containing organometallic compounds.

In some instances, the composition reinforcing filler has 100 parts per million (ppm) or less of elements selected from the group consisting of mercury, lead, cadmium, tin, antimony, arsenic and thallium.

The reinforcing filler can be present in an amount of 10 to 40 wt %, for example, preferably 15 to 25 wt %, wherein weight percent is based on the total weight of the reinforced polyetherimide composition.

The reinforced polyetherimide composition comprises a flow promoter comprising an aromatic phosphate, a phosphazene, or a combination comprising at least one of the foregoing.

An aromatic phosphate has the formula (GO)₃P═O, wherein each G is independently a C₁₋₁₂ alkyl, C₃₋₈ cycloalkyl, C₆₋₁₂ aryl, C₇₋₁₃ alkylarylene, or C₇₋₁₃ arylalkylene group, provided that at least one G is an aromatic group. Two of the G groups can be joined together to provide a cyclic group. Aromatic phosphates include, for example, phenyl bis(dodecyl) phosphate, phenyl bis(neopentyl) phosphate, phenyl bis(3,5,5′-trimethylhexyl) phosphate, ethyl diphenyl phosphate, 2-ethylhexyl di(p-tolyl) phosphate, bis(2-ethylhexyl) p-tolyl phosphate, tritolyl phosphate, bis(2-ethylhexyl) phenyl phosphate, tri(nonylphenyl) phosphate, bis(dodecyl) p-tolyl phosphate, dibutyl phenyl phosphate, 2-chloroethyl diphenyl phosphate, p-tolyl bis(2,5,5′-trimethylhexyl) phosphate, 2-ethylhexyl diphenyl phosphate, and the like. A specific aromatic phosphate is one in which each G is aromatic, for example, triphenyl phosphate, tricresyl phosphate, isopropylated triphenyl phosphate, and the like.

Di- or polyfunctional aromatic phosphorus-containing compounds are also useful, for example, compounds of formula (7)

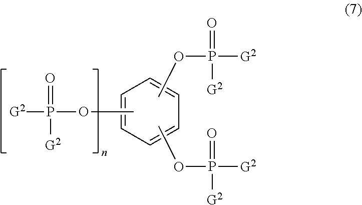

wherein each G² is independently a hydrocarbon or hydrocarbonoxy having 1 to 30 carbon atoms and n is 0 to 3.

Specific aromatic organophosphorus compounds have two or more phosphorus-containing groups, and are inclusive of acid esters of formula (8)

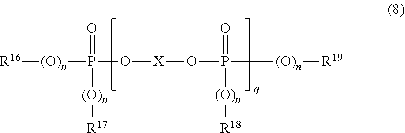

wherein R¹⁶, R¹⁷, R¹⁸, and R¹⁹ are each independently C₁₋₈ alkyl, C₅₋₆ cycloalkyl, C₆₋₂₀ aryl, or C₇₋₁₂ arylalkylene, each optionally substituted by C₁₋₁₂ alkyl, specifically by C₁₋₄ alkyl and X is a mono- or poly-nuclear aromatic C₆₋₃₀ moiety or a linear or branched C₂₋₃₀ aliphatic radical, which can be OH-substituted and can contain up to 8 ether bonds, provided that at least one of R¹⁶, R¹⁷, R¹⁸, R¹⁹, and X is an aromatic group. In some embodiments R¹⁶, R¹⁷, R¹⁸, and R¹⁹ are each independently C₁₋₄ alkyl, naphthyl, phenyl(C₁₋₄)alkylene, or aryl groups optionally substituted by C₁₋₄ alkyl. Specific aryl moieties are cresyl, phenyl, xylenyl, propylphenyl, or butylphenyl. In some embodiments X in formula (8) is a mono- or poly-nuclear aromatic C₆₋₃₀ moiety derived from a diphenol. Further in formula (8), n is each independently 0 or 1; in some embodiments n is equal to 1. Also in formula (8), q is from 0.5 to 30, from 0.8 to 15, from 1 to 5, or from 1 to 2. Specifically, X can be represented by the following divalent groups (9), or a combination comprising one or more of these divalent groups.

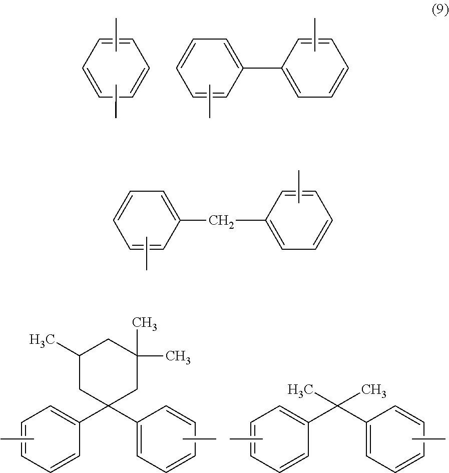

In these embodiments, each of R¹⁶, R¹⁷, R¹⁸, and R¹⁹ can be aromatic, i.e., phenyl, n is 1, and p is 1-5, specifically 1-2. In some embodiments at least one of R¹⁶, R¹⁷, R¹⁸, R¹⁹, and X corresponds to a monomer used to form the polycarbonate, e.g., bisphenol A or resorcinol. In another embodiment, X is derived especially from resorcinol, hydroquinone, bisphenol A, or diphenylphenol, and R¹⁶, R¹⁷, R¹⁸, R¹⁹, is aromatic, specifically phenyl. A specific aromatic organophosphorus compound of this type is resorcinol bis(diphenyl phosphate), also known as RDP. Another specific class of aromatic organophosphorus compounds having two or more phosphorus-containing groups are compounds of formula (10)

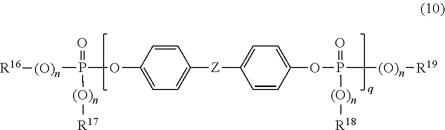

wherein R¹⁶, R¹⁷, R¹⁸, R¹⁹, n, and q are as defined for formula (19) and wherein Z is C₁₋₇ alkylidene, C₁₋₇ alkylene, C₅₋₁₂ cycloalkylidene, —O—, —S—, —SO₂—, or —CO—, specifically isopropylidene. A specific aromatic organophosphorus compound of this type is bisphenol A bis(diphenyl phosphate), also known as BPADP, wherein R¹⁶, R¹⁷, R¹⁸, and R¹⁹ are each phenyl, each n is 1, and q is from 1 to 5, from 1 to 2, or 1.

In an aspect, the aromatic phosphate is bisphenol A diphosphate, resorcinol diphosphate, biphenol diphosphate, hydroquinone diphosphate, acetophenone bisphenol diphosphate, dihydroxy diphenyl ether diphosphate, or a combination comprising at least one of the foregoing.

The aromatic phosphate can be present in an amount of 0.1 to 10 wt %, for example, 0.1 to 3 wt %, for example, or 1 to 3 wt %, wherein wt % is based on the total weight of the reinforced polyetherimide composition.

Phosphazenes include phosphazenes (11) and cyclic phosphazenes (12)

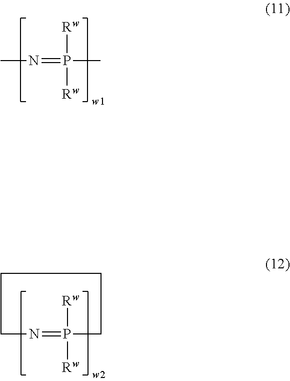

can be used, wherein w1 is 3 to 10,000 and w2 is 3 to 25, specifically 3 to 7, and each R^{w} is independently a C₁₋₁₂ alkyl, alkenyl, alkoxy, aryl, aryloxy, or polyoxyalkylene group. In the foregoing groups at least one hydrogen atom of these groups can be substituted with a group having an N, S, O, or F atom, or an amino group. For example, each R^{w} can be a substituted or unsubstituted phenoxy, an amino, or a polyoxyalkylene group. Any given R^{w} can further be a crosslink to another phosphazene group. Exemplary crosslinks include bisphenol groups, for example bisphenol A groups. Examples include phenoxy cyclotriphosphazene, octaphenoxy cyclotetraphosphazene decaphenoxy cyclopentaphosphazene, and the like. A combination of different phosphazenes can be used. A number of phosphazenes and their synthesis are described in H. R. Allcook, “Phosphorus-Nitrogen Compounds” Academic Press (1972), and J. E. Mark et al., “Inorganic Polymers” Prentice-Hall International, Inc. (1992).

In an aspect, the phosphazene is SBP-100, poly(bis(phenoxy)phosphazene). The phosphazene can be present in an amount of 0.1 to 10 wt %, for example, 0.1 to 3 wt %, for example, 1 to 3 wt %, wherein wt % is based on the total weight of the reinforced polyetherimide composition.

In an embodiment, the flow promoter has a molecular weight from 500 to 1,200 Daltons. When the flow promoter comprises a combination of an aromatic phosphate and a phosphazene, the weight ratio of the aryl phosphate to the phosphazene is, for example, 1 to 1.

The reinforced polyetherimide composition also comprises a liquid crystalline polymer (LCP) reinforcing agent.

The term “liquid crystalline polymer” generally refers to a polymer that can possess a rod-like structure that allows it to exhibit liquid crystalline behavior in its molten state. The polymer can contain aromatic units (e.g., aromatic polyesters, aromatic polyethers, aromatic polyesteramides, etc.) so that it is wholly aromatic (e.g., containing only aromatic units) or partially aromatic (e.g., containing aromatic units and other units, such as cycloaliphatic units). Liquid crystalline polymers are generally classified as “thermotropic” to the extent that they can possess a rod-like structure and exhibit a crystalline behavior in their molten state. Because thermotropic liquid crystalline polymers form an ordered phase in the melt state, they can have a relatively low shear viscosity and thus act as a flow aid for the high performance polymer. An exemplary liquid crystalline polymer is a wholly aromatic liquid crystal polyether resin.

Exemplary liquid crystalline polymers include co-polyesters, co-polyesteramides, multiple half or wholly aromatic polyesters, or combinations comprising at least one of the foregoing. In an aspect, when the composition comprises a liquid crystalline polymer, the weight ratio of the flow promoter to the liquid crystalline polymer is 0.1:20 to 1:5.

In addition to the above-described components, the polyetherimide composition can include various additives ordinarily incorporated into thermoplastic compositions, with the proviso that the additives are selected so as to not significantly adversely affect the desired properties of the polyetherimide composition, for example the melt flow, elongation, strength, impact, and flame retardant properties. Such additives can be mixed at a suitable time during the mixing of the components for forming the composition. Additives can include impact modifiers, fillers, antioxidants, heat stabilizers, light stabilizers, ultraviolet (UV) light stabilizers, lubricants, mold release agents, antistatic agents, colorants such as such as titanium dioxide, carbon black, and organic dyes, surface effect additives, radiation stabilizers, flame retardants, and anti-drip agents. A combination of additives can be used, for example a combination of a heat stabilizer, mold release agent, and ultraviolet light stabilizer. The additives are used in the amounts generally known to be effective. For example, the total amount of the additives (other than any impact modifier, filler, or reinforcing agents) can be 0.01 to 5 wt % based on the total weight of the reinforced polyetherimide composition.

The polyetherimide composition can optionally further include other polymeric additives for example thermoplastic polymers including polycarbonates (e.g., bisphenol A polycarbonate), polyester-carbonates, polyesters, polysulfones, and polyamides. In some embodiments, no additional thermoplastic polymers are included, or thermoplastic polymers other than the polyetherimide can be excluded from the polyetherimide composition.

In some embodiments, the thermoplastic composition can be essentially free of halogens, for example, fluorine, chlorine, and/or bromine. “Essentially free of fluorine, chlorine and bromine” is defined as having a fluorine and/or bromine and/or chlorine content of less than or equal to 100 parts per million by weight (ppm), less than or equal to 75 ppm, or less than or equal to 50 ppm, based on the total parts by weight of the reinforced polyetherimide composition.

The reinforced polyetherimide compositions can be manufactured by various methods according to general techniques which are known. The polyetherimide compositions described herein can generally be made by melt-blending the components using any known methods. For example, a polyetherimide and an aryl phosphate, and other optional components can be first blended in a HENSCHEL-Mixer® high speed mixer. Other low shear processes, including but not limited to hand-mixing, can also accomplish this blending. The blend can then be fed into a twin-screw extruder via a hopper. Alternatively, at least one of the components can be incorporated into the composition by feeding directly into the extruder at the throat and/or downstream through a side-stuffer. Additives can also be compounded into a masterbatch containing the desired polyetherimide and fed into the extruder. Generally, the polyetherimide compositions can be melt-processed at temperatures of 240 to 340° C. The extrudate can be quenched in a water bath and pelletized. The pellets so prepared can be one-fourth inch long or less as desired. Such pellets can be used for subsequent molding, shaping, or forming.

The reinforced polyetherimide composition can have one or more of the following properties: a melt flow rate (MFR), measured according to ASTM D1238 (2015) at 337° C. under a 6.7 kgf load, that is at least 10% higher than that of the same reinforced polyetherimide composition without the flow promoter; a capillary melt viscosity, measured according to ASTM D3835 (2015) at a shear rate of 5000 l/s and a temperature of 380° C. that is at least 10% lower than that of the same reinforced polyetherimide composition without the flow promoter; a total average flame out time of less than or equal to 2.5 seconds, preferably less than or equal to 1.4 seconds, wherein the total average flame out time of the reinforced polyetherimide composition is less than the total average flame out time for the same reinforced polyetherimide composition with no added aryl phosphate or phosphazene, measured according to Underwriters Laboratory test bulletin UL94 using 1.5 millimeter samples.

In an aspect, the flow promoter is present in an amount ineffective to decrease flexural modulus measured according to ASTM D790, flexural strength measured according to ASTM D790, tensile modulus measured according to ASTM D648, coefficient of thermal expansion measured according to ISO 11359-2, or a combination thereof, by more than 10%, or by more than 5%, or by more than 1%, compared to the same reinforced polyetherimide composition without the flow promoter.

The reinforced polyetherimide compositions of the present disclosure can be formed into articles using any suitable techniques, for example, melt-processing techniques. Commonly used melt-molding methods can include injection molding, extrusion molding, blow molding, rotational molding, coining, and injection blow molding. For example, the melt molding method can be injection molding. The compositions of the present disclosure can be formed into sheets and both cast and blown films by extrusion. The compositions of the present disclosure can also be pressure molded. These films and sheets can be further thermoformed into articles and structures that can be oriented from the melt or at a later stage in the processing of the composition. The compositions can be over-molded onto an article made from a different material and/or by a different process. The articles can also be formed using techniques such as compression molding or ram extruding. The articles can be further formed into other shapes by machining. Exemplary articles can include an electrical connector, an electrical socket, a circuit board, a circuit board component, a computer component, a display screen component, a communication device component, or a component of a hand-held electronic device. In these applications, the combination of high melt flow and increased stiffness (i.e., modulus) and strength are especially valuable as electronic devices become thinner. For example, thin, light-weight cell phones or computer tablets must be rigid enough so as not to flex excessively, thereby causing damage to the electronic components.

In a specific embodiment, the article is a thin article, for example a housing for an electronic device, the thin article having a maximum thickness of 3 centimeters (cm), 2.5 cm, 2 cm, 1 cm, 0.5, or 0.2 cm. At least some portion of the article can have a thickness of 0.01 to 2.0 millimeters (mm), for example, at least some portion of the article can have a thickness of 0.1 to 2 mm, or 0.5 to 2 mm. The article can have a length that is at least 10 times the thickness, for example, the length of the article can be at least 100 times the thickness. In some embodiments, the longest aspect of the article can be at least 5 cm.

The reinforced polyetherimide compositions have no limitation of the utilization field thereof for molded articles. The reinforced polyetherimide compositions can be advantageously used in applications where a combination of improved melt flow and enhanced physical properties including impact strength and thermal stability and flame retardancy are required. The reinforced polyetherimide compositions can further be advantageously used in applications where transparent articles are required.

The articles prepared from the compositions of the present disclosure can be used in applications including consumer goods, office equipment, computers, electronic or communication devices, automotive parts, domestic or industrial machine tools, lawn equipment, and domestic appliances. The term “automotive” refers to applications with respect to any vehicle of transportation, for example cars, trucks, motorcycles, scooters, motor bicycles, boats, and sport vehicles. The articles can include a wide array of devices, or components of a device, for a variety of industries and applications for example, electrical, communication, transportation, medical, information management, material handling, manufacturing, food service, storage, industrial applications, and personal care products. The articles can have snap fit connectors to facilitate attachment to more complex devices. The articles can also have holes or apertures.

The invention is further illustrated by the following non-limiting examples.

### EXAMPLES

All tests are based on ASTM and ISO standards, test year 2015, as provided in Table A.

TABLE A

| | Test | Default Specimen | |
|---|---|---|---|
| | Standard | Type | Units |
| Flexural (Flex) | ASTM D790 | Bar - 127 × 12.7 × | Mpa |
| Test | | 3.2 mm | |
| Heat distortion | ASTM D648 | Bar - 127 × 12.7 × | ° C. |
| temperature (HDT) | | 3.2 mm | |
| Filled Tensile Test | ASTM D638 | ASTM Type I Ten- | Mpa |
| | | sile bar | |
| Notched Izod | Notched | Bar - 63.5 × 12.7 × | J/m |
| Impact (23° C.) | ASTM D256 | 3.2 mm | |
| Capillary melt | ASTM D3835 | Pellets | Pa · s |
| viscosity | | | |
| Melt flow rate | ASTM D1238 | Pellets | g/10 min |
| (MFR) | | | |
| Coefficient of | ISO 11359-2 | Multi-purpose ISO | um/ |
| Thermal Expansion | | 3167 Type A | (m-° C.) |
| (CTE) | | | |
| Spiral Flow | | | cm |
| Flame retardance | UL94 | | |

### Preparation of Control and Example Polyetherimide Compositions.

The control sample and all examples are polymer compositions filled with mixed fillers of different ratios. All of the components except the glass fiber reinforcing filler were dry blended for 3-5 minutes in a super-floater. The resins were pre-dried at 150° C. for about 4 hours before extrusion. The glass fiber was fed at the down-stream with a side feeder. The blends were added at the throat. Formulations were compounded on a 37 mm Toshiba twin-screw with vacuum vented extruder at a 340-360° C. barrel set temperature with 300-350 rpm and 55-60 kg/hr. After compounding, the pellets were dried 4-6 hr at 150° C. and injection molded on a 110 ton Fanuc injection molding machine; ASTM bars were molded with a barrel temperature setting at 340-360° C. and mold temperature 150° C. The raw materials are provided in Table B.

TABLE B

| Component | Description | Source |
|---|---|---|
| PEI | Polyetherimide (ULTEM (TM) | SABIC |
| | 1010) | |
| LCP | Wholly aromatic liquid crystal | UNEO Fine Chemicals |
| | polyether (LCP A2500) | Industry, Ltd. |
| Glass | Glass fiber | Owens Corning |
| Fibers | | |
| BPADP | Bisphenol-A-bis(diphenyl | DAIHACHI Chemical |
| | phosphate) | Industry Co. Ltd. |
| RDP | Resorcinol bis(diphenyl | Jiangsu Yoke |
| | phosphate) | Technology Co., Ltd. |
| SPB | Phosphazene | Otsuka Chemical |
| | | Co., Ltd. |

In addition to the above materials, each formulation contained and additive package including an antioxidant, and a hindered phenol stabilizer.

### Example Series 1

A control and a series of examples were prepared as described above, using the materials and amounts shown in Table 1. The control reinforced polyetherimide compositions contained 20 wt % chopped glass filler and 10 wt % liquid crystalline polymer. The Example 1 series of reinforced polyetherimide compositions contained 20 wt % chopped glass filler and 10 wt % liquid crystalline polymer, in addition to 1 wt % each of bisphenol-A-bis(diphenyl phosphate), resorcinol bis(diphenyl phosphate), or phosphazene. Samples were tested, and the results are also shown in Table 1.

TABLE 1

| | Unit | Control | Ex. 1-1 | Ex. 1-2 | Ex. 1-3 |
|---|---|---|---|---|---|
| Components | | | | | |
| PEI | wt % | 66.7 | 65.7 | 65.7 | 65.7 |
| Glass Fibers | wt % | 20 | 20 | 20 | 20 |
| LCP | wt % | 10 | 10 | 10 | 10 |
| BPADP | wt % | | 1 | | |
| RDP | wt % | | | 1 | |
| Phosphazene | wt % | | | | 1 |
| Additives | wt % | 3.3 | 3.3 | 3.3 | 3.3 |
| Results | | | | | |
| MFR, 337° C./6.7 kgf | g/10 min | 16.1 | 20.3 | 18.8 | 21.2 |
| Flex Modulus, 2.6 mm/min, 100 mm span | MPa | 7550 | 7300 | 7690 | 7430 |
| Flex strength, yld, 2.6 mm/min, 100 mm span | MPa | 193 | 188 | 195 | 191 |
| Tensile Modulus, 5 mm · min | MPa | 9375 | 9296 | 9462 | 9406 |
| Tensile Strength (SG*), brk, 5 mm/min | MPa | 151 | 159.7 | 157 | 158.9 |
| HDT, 1.82 MPa, 3.2 mm | ° C. | 203 | 198 | 198 | 198 |
| Notched Izod Impact, 23° C. | J/m | 86.7 | 87.7 | 91.4 | 87.4 |
| Capillary melt viscosity at 5000 1/s, at 380° C. | Pa · s | 67.2 | 56.32 | 41.23 | 58.38 |
| CTE, flow | um/(m-° C.) | 14.47 | 13.94 | 18.07 | 15.77 |
| CTE, x-flow | um/(m-° C.) | 60.61 | 61.27 | 61.34 | 65.2 |
| Spiral Flow, 380° C., 0.5 mm | cm | 7.3 | 9.2 | 9.1 | 8.5 |
| UE94 V0 at 1.5 mm Time 1 (Avg) | s | 1.23 | 0.79 | 0.74 | 0.88 |
| UE94 V0 at 1.5 mm Time 2 (Avg) | s | 2.99 | 2.51 | 2.24 | 2.08 |
| p(FTP) | | 0.9877 | 1 | 1 | 0.9999 |

*SG means the test bar was molded by the “single gate” molding method.

The Control Sample showed balanced mechanical, heat, and Izod properties. The flowability is also good, but the sample could not meet higher flowability requirements for molding thin wall electronics applications.

In contrast, compared with the control sample, the Example 1 series showed improved flowability, as the MFR and the spiral flow were at least 10% greater than that of the control sample, and the capillary melt viscosity was at least 10% lower than that of the control sample, and the spiral flow. The Example 1 series also had comparable mechanical, heat, and dimensional stability properties compared to the control. Furthermore, the IZOD impact and flame retardancy showed certain increases compared to the control sample.

### Example Series 2

A control and a series of examples were prepared as described above, using the materials and amounts shown in Table 2. The Example 2 series of reinforced polyetherimide composition contained 20 wt % chopped glass filler and 10 wt % liquid crystalline polymer with 0.5 to 5 wt % bisphenol-A-bis(diphenyl phosphate) as the flow promoter as indicated in Table 2. Samples were tested, and the results are also shown in Table 2.

TABLE 2

| | Unit | Control | Ex. 2-1 | Ex. 2-2 | Ex. 2-3 | Ex. 2-4 |
|---|---|---|---|---|---|---|
| Components | | | | | | |
| PEI | wt % | 66.7 | 66.2 | 65.7 | 63.7 | 61.7 |
| Glass fibers | wt % | 20 | 20 | 20 | 20 | 20 |
| LCP | wt % | 10 | 10 | 10 | 10 | 10 |
| BPADP | wt % | 0.5 | 1 | 3 | 5 | |
| Additives | wt % | 3.3 | 3.3 | 3.3 | 3.3 | 3.3 |
| Results | | | | | | |
| MFR, 337° C./6.7 kgf | g/10 min | 16.1 | 20.6 | 20.3 | 25.1 | 38.2 |
| Flex Modulus, 2.6 mm/min, 100 | MPa | 7550 | 7510 | 7300 | 7560 | 7550 |
| mm span | | | | | | |
| Flex strength, yield, 2.6 mm/min, | MPa | 193 | 187 | 188 | 191 | 193 |
| 100 mm span | | | | | | |
| Tensile Modulus, 5 mm · min | MPa | 9375 | 9401 | 9296 | 9354 | 9897.8 |
| Tensile Strength (SG), brk, 5 | MPa | 151 | 155.4 | 159.7 | 161.1 | 166.3 |
| mm/min | | | | | | |
| HDT, 1.82 MPa, 3.2 mm | ° C. | 203 | 201 | 198 | 189 | 176 |
| Notched Impact, 23° C. | J/m | 86.7 | 84 | 87.7 | 89.4 | 90.2 |
| Capillary melt viscosity at | Pa · s | 67.2 | 58.47 | 56.32 | 48.72 | 41.76 |
| 5000 1/s, 380° C. | | | | | | |
| CTE, flow | um/(m-° C.) | 14.47 | 16.8 | 13.94 | 15.38 | 18.13 |
| CTE, x-flow | um/(m-° C.) | 60.61 | 59.18 | 61.27 | 60.64 | 59.36 |
| Spiral Flow, 380° C., 0.5 mm | cm | 7.3 | 9.8 | 9.2 | 11.9 | 13.4 |
| Flammability, UL94 V0 at 1.5 mm | s | 1.23 | 0.76 | 0.79 | 0.7 | 0.78 |
| Time 1 (Avg) | | | | | | |
| Flammability, UL94 V0 at 1.5 mm | s | 2.99 | 2.54 | 2.51 | 1.54 | 1.39 |
| Time 2 (Avg) | | | | | | |
| p(FTP) | | 0.9877 | 1 | 1 | 1 | 1 |

As shown in Table 2, the Example 2 series showed that the flowability gradually increased with bisphenol-A-bis(diphenyl phosphate) content by at least 10% and more preferably at least 60% greater compare to the control sample. The other properties were similar to the Example 1 series. The only negative finding was a decrease in HDT observed with increasing amounts of bisphenol-A-bis(diphenyl phosphate) content versions.

### Example Series 3

A control and a series of examples were prepared as described above, using the materials and amounts shown in Table 3. The Example 3 series of reinforced polyetherimide compositions contained 10 to 30 wt % chopped glass filler and 10 wt % liquid crystalline polymer with or without 1 wt % bisphenol-A-bis(diphenyl phosphate) as the flow promoter as shown in Table 3. Samples were tested, and the results are also shown in Table 3.

TABLE 3

| | Unit | Control | Ex. 3-1* | Ex. 3-2 | Ex. 3-3* | Ex. 3-4 | Ex. 3-5* | Ex. 3-6 |
|---|---|---|---|---|---|---|---|---|
| Components | | | | | | | | |
| PEI | wt % | 66.7 | 76.7 | 75.7 | 66.7 | 65.7 | 56.7 | 55.7 |
| Glass fibers | wt % | 20 | 10 | 10 | 20 | 20 | 30 | 30 |
| LCP | wt % | 10 | 10 | 10 | 10 | 10 | 10 | 10 |
| BPADP | wt % | | | 1 | | 1 | | 1 |
| Additives | wt % | 3.3 | 3.3 | 3.3 | 3.3 | 3.3 | 3.3 | 3.3 |
| Results | | | | | | | | |
| MFR, 337° C./6.7 kgf | g/10 min | 16.1 | 29.6 | 26.6 | 16.1 | 20.3 | 9.8 | 14.4 |
| Flex Modulus, 2.6 mm/min, 100 mm | MPa | 7550 | 5540 | 5520 | 7550 | 7300 | 10000 | 9800 |
| span | | | | | | | | |
| Flex strength, yld, 2.6 mm/min, 100 | MPa | 193 | 173 | 167 | 193 | 188 | 241 | 231 |
| mm span | | | | | | | | |
| Tensile Modulus, 5 mm · min | MPa | 9375 | 6490.8 | 6481.2 | 9375 | 9296 | 12254 | 122467 |
| Tensile Strength (SG), brk, 5 | MPa | 151 | 132.5 | 136.8 | 151 | 159.7 | 179.5 | 182 |
| mm/min | | | | | | | | |
| HDT, 1.82 MPa, 3.2 mm | ° C. | 203 | 198 | 196 | 203 | 203 | 203 | 198 |
| Notched Izod Impact, 23° C. | J/m | 86.7 | 64.5 | 72.7 | 86.7 | 87.7 | 97 | 100 |
| Capillary melt viscosity at 5000 1/s, | Pa · s | 67.2 | 58.83 | 49.34 | 67.2 | 56.32 | 71.18 | 66.36 |
| 380° C. | | | | | | | | |
| CTE, flow | um/(m-° C.) | 14.47 | 17.01 | 22.1 | 14.47 | 13.94 | 10.57 | 11.78 |
| CTE, x-flow | um/(m-° C.) | 60.61 | 64.09 | 61.84 | 60.61 | 94.27 | 56.4 | 53.57 |
| Spiral Flow, 380° C., 0.5 mm | cm | 7.3 | 7.9 | 10.1 | 7.3 | 9.2 | 5.7 | 8.6 |
| Flammability, UL94 V0 at 1.5 mm | sec | 1.23 | 1.49 | 1.08 | 1.23 | 0.79 | 1.29 | 0.73 |
| Time 1 (Avg) | | | | | | | | |
| Flammability, UL94 V0 at 1.5 mm | sec | 2.99 | 2.02 | 1.49 | 2.99 | 2.51 | 2.81 | 1.9 |
| Time 2 (Avg) | | | | | | | | |
| p(FTP) | | 0.9877 | 0.9833 | 0.9999 | 0.9877 | 1 | 0.9999 | 0.9999 |

*Comparative examples

The Example 3 series showed that the bisphenol-A-bis(diphenyl phosphate) flow promoter can increase the flowability of the composition even at a higher content of glass filler compared to the compositions without bisphenol-A-bis(diphenyl phosphate).

### Example Series 4

A control and a series of examples were prepared as described above, using the materials and amounts shown in Table 4. The Example 4 series reinforced polyetherimide compositions contained 20 wt % chopped glass filler and 5 to 15 wt % liquid crystalline polymer with 1 wt % bisphenol-A-bis(diphenyl phosphate) as the flow promoter. Samples were tested, and the results are shown in Table 4.

TABLE 4

| | Unit | Control | Ex. 4-1* | Ex. 4-2 | Ex. 4-3* | Ex. 4-4 | Ex. 4-5* | Ex. 4-6 |
|---|---|---|---|---|---|---|---|---|
| Components | | | | | | | | |
| PEI | wt % | 66.7 | 71.7 | 70.7 | 66.7 | 65.7 | 61.7 | 60.7 |
| Glass fibers | wt % | 20 | 20 | 20 | 20 | 20 | 20 | 20 |
| LCP | wt % | 10 | 5 | 5 | 10 | 10 | 15 | 15 |
| BPADP | wt % | | | 1 | | 1 | | 1 |
| RDP | wt % | | | | | | | |
| SPB | wt % | | | | | | | |
| Additives | wt % | 3.3 | 3.3 | 3.3 | 3.3 | 3.3 | 3.3 | 3.3 |
| Results | | | | | | | | |
| MFR, 337° C./6.7 kgf | g/10 min | 16.1 | 13.1 | 16.3 | 16.1 | 20.3 | 22.8 | 28.1 |
| Flex Modulus, 2.6 mm/min, 100 mm | MPa | 7550 | 7260 | 7160 | 7550 | 7300 | 7990 | 7790 |
| span | | | | | | | | |
| Flex strength, yield, 2.6 mm/min, 100 | MPa | 193 | 217 | 209 | 193 | 188 | 194 | 178 |
| mm span | | | | | | | | |
| Tensile Modulus, 5 mm · min | MPa | 9375 | 8525.2 | 8670 | 9375 | 9296 | 9942.4 | 9881 |
| Tensile Strength (SG), break, 5 | MPa | 151 | 178.6 | 176.5 | 151 | 159.7 | 141.4 | 138.8 |
| mm/min | | | | | | | | |
| HDT, 1.82 MPa, 3.2 mm | ° C. | 203 | 204 | 198 | 203 | 203 | 203 | 198 |
| Notched Impact, 23° C. | J/m | 86.7 | 90.2 | 88.9 | 86.7 | 87.7 | 83.7 | 86.2 |
| Capillary melt viscosity at 5000 1/s, | Pa · s | 67.2 | 77.92 | 70.87 | 67.2 | 56.32 | 35.57 | 34.41 |
| 380° C. | | | | | | | | |
| CTE, flow | um/(m-° C.) | 14.47 | 15.64 | 15.96 | 14.47 | 13.94 | 15.78 | 17.01 |
| CTE, x-flow | um/(m-° C.) | 60.61 | 60.01 | 59.61 | 60.61 | 94.27 | 62 | 62.06 |
| Spiral Flow, 380° C., 0.5 mm | cm | 7.3 | 1.2 | 3.7 | 7.3 | 9.2 | 11.6 | 13.6 |
| Flammability, UL94 V0 at 1.5 mm | s | 1.23 | 1.3 | 0.68 | 1.23 | 0.79 | 1.07 | 0.78 |
| Time 1 (Avg) | | | | | | | | |
| Flammability, UL94 V0 at 1.5 mm | s | 2.99 | 1.89 | 1.71 | 2.99 | 2.51 | 3.61 | 2.54 |
| Time 2 (Avg) | | | | | | | | |
| p(FTP) | | 0.9877 | 0.9999 | 0.9999 | 0.9877 | 1 | 0.9912 | 0.9987 |

*Control

As shown in Table 4, the Example 4 series show that the combination of liquid crystalline polymer and BPADP in different ratios could both increase the flowability of the composition while maintaining mechanical properties, flame retardancy, and heat and dimensional stability.

In summary, Example series 1 to 4 show that the aryl phosphate and phosphazene flow promoters provide improved the flow ability and better IZOD and flame retardant properties compared with the control example. Also, the mechanical properties, heat, and dimensional stability are well maintained.

The polyetherimide compositions, methods of manufacture, and articles made therefrom are further illustrated by the following aspects, which are non-limiting.

Aspect 1. A reinforced polyetherimide composition comprises: 50 to 99.9 wt % of a polymer composition comprising a polyetherimide having a weight average molecular weight of 5,000 to 80,000 Daltons; 10 to 40 wt % of a reinforcing filler; 0.1 to 10 wt % of flow promoter, wherein the flow promoter comprises an aromatic phosphate, a phosphazene, or a combination comprising at least one of the foregoing; 0 to 20 wt % of a liquid crystalline polymer; wherein wt % is based on the total weight of the reinforced polyetherimide composition; and wherein the reinforced polyetherimide composition has a melt flow rate (MFR), measured according to ASTM D1238 (2015) at 337° C. under a 6.7 kgf load, that is at least 10% higher than that of the same reinforced polyetherimide composition without the flow promoter, and a capillary melt viscosity, measured according to ASTM D3835 (2015) at a shear rate of 5000 l/s and a temperature of 380° C., that is at least 10% lower than that of the same reinforced polyetherimide composition without the flow promoter.

Aspect 2. The reinforced polyetherimide composition of aspect 1, wherein the flow promoter has a molecular weight from 500 to 1,200 Daltons.

Aspect 3. The reinforced polyetherimide composition of aspect 1 or aspect 2, wherein the weight ratio of the flow promoter to the liquid crystalline polymer is 0.1:20 to 1:5.

Aspect 4. The reinforced polyetherimide composition of any one or more of aspects 1 to 3, wherein the polyetherimide comprises units of the formula

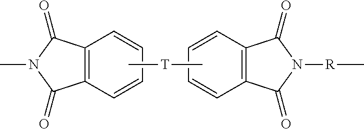

wherein R is a C₂₋₂₀ hydrocarbon group, T is —O— or a group of the formula —O—Z—O— wherein the divalent bonds of the —O— or the —O—Z—O— group are in the 3,3′, 3,4′, 4,3′, or the 4,4′ positions, and

Z is an aromatic C₆₋₂₄ monocyclic or polycyclic group optionally substituted with 1 to 6 C₁₋₈ alkyl groups, 1-8 halogen atoms, or a combination comprising at least one of the foregoing.

Aspect 5. The reinforced polyetherimide composition of aspect 4, wherein R is a divalent group of the formula

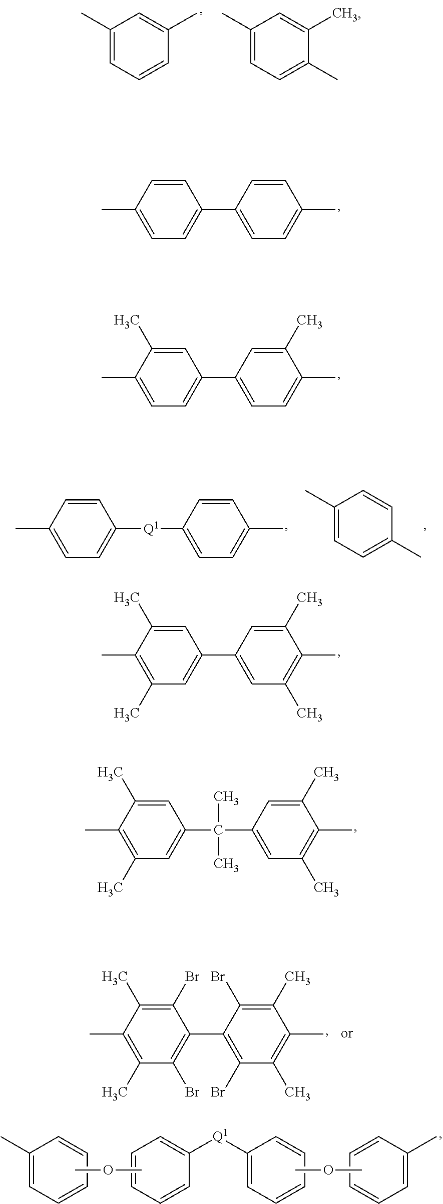

wherein Q¹ is —O—, —S—, —C(O)—, —SO₂—, —SO—, —C_{y}H_{2y}— and a halogenated derivative thereof wherein y is an integer from 1 to 5, or —(C₆H₁₀)_{z}— wherein z is an integer from 1 to 4; and Z is a group derived from a dihydroxy compound of the formula

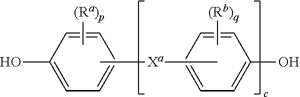

wherein R^{a} and R^{b} are each independently a halogen atom or a monovalent C₁₋₆ alkyl group; p and q are each independently integers of 0 to 4; c is 0 to 4; and X^{a} is a single bond, —O—, —S—, —S(O)—, —SO₂—, —C(O)—, or a C₁₋₁₈ organic bridging group.

Aspect 6. The reinforced polyetherimide composition of any one or more of aspects 4 to 5, wherein each R is independently meta-phenylene, para-phenylene, or a combination comprising at least one of the foregoing, and Z is 4,4′-diphenylene isopropylidene.

Aspect 7: The reinforced polyetherimide composition of any one or more of claims 1 to 6, wherein the polymer composition comprises 10 to 99 weight percent of the polyetherimide and 90 to 1 weight percent of a polymer different from the polyetherimide.

Aspect 8: The reinforced polyetherimide composition of claim 7, wherein the polymer different from the polyetherimide comprises a polyamide, polyamideimide, polyarylene ether, polyarylene ether ketone, polyarylene sulfide, polyarylene sulfone, polycarbonate, polyester, polyimide, polyphenylenesulfone urea, polyphthalamide, self-reinforced polyphenylene, or a combination comprising at least one of the foregoing.

Aspect 9. The reinforced polyetherimide composition of any one or more of aspects 1 to 8, wherein the reinforcing filler comprises glass fiber, carbon fiber, titanium dioxide, clay, talc, mica, silica, mineral filler, wollastonite, glass spheres, flaked glass, milled glass, carbon black, or a combination comprising at least one of the foregoing.

Aspect 10. The reinforced polyetherimide composition of any one or more of aspects 1 to 9, wherein the flow promoter comprises an aromatic phosphate, and the aromatic phosphate is a bisphenol A diphosphate, resorcinol diphosphate, biphenol diphosphate, hydroquinone diphosphate, acetophenone bisphenol diphosphate, dihydroxy diphenyl ether diphosphate, or a combination comprising at least one of the foregoing.

Aspect 11. The reinforced polyetherimide composition of any one or more of aspects 1 to 10, wherein the flow promoter comprises a phosphazene, and the phosphazene is poly(bis(phenoxy)phosphazene).

Aspect 12. The reinforced polyetherimide composition of any one or more of aspects 1 to 11, wherein the flow promoter comprises an aryl phosphate and a phosphazene in a 1 to 1 weight ratio.

Aspect 13. The reinforced polyetherimide composition of any one or more of aspects 1 to 12, wherein the reinforced polyetherimide composition comprises a liquid crystalline polymer, and the liquid crystalline polymer is a co-polyester, a co-polyesteramide, a multiple half or wholly aromatic polyester, or a combination comprising at least one of the foregoing.

Aspect 14. The reinforced polyetherimide composition of any one or more of aspects 1 to 13, wherein the polyetherimide composition has a total average flame out time of less than or equal to 2.5 seconds, preferably less than or equal to 1.4 seconds, wherein the total average flame out time of the reinforced polyetherimide composition is less than the total average flame out time for the same reinforced polyetherimide composition with no added aryl phosphate or phosphazene, measured according to Underwriters Laboratory test bulletin UL94 using 1.5 millimeter samples.

Aspect 14. The reinforced polyetherimide composition of any one or more of aspects 1 to 14, wherein the flow promoter is present in an amount ineffective to decrease flexural modulus measured according to ASTM D790, flexural strength measured according to ASTM D790, tensile modulus measured according to ASTM D648, coefficient of thermal expansion measured according to ISO 11359-2, or a combination comprising at least one of the foregoing, by more than 10%, or by more than 5%, or by more than 1%, compared to the same reinforced polyetherimide composition without the flow promoter.

Aspect 15. An article comprising the reinforced polyimide of any one or more of aspects 1 to 15.

Aspect 16. The article of claim 16, comprising a pressure molded, injection molded, or extruded article, preferably a molded article.

Aspect 17. The article of claim 16 or claim 17, wherein the article is an electrical connector, an electrical socket, a circuit board, a circuit board component, a computer component, a display screen component, a communication device component, or a component of a hand-held electronic device.

Aspect 19. The article of any one or more of claims 16 to 18, wherein the article has a thickness of 0.01 to 2 millimeter, or 0.1 to 2 millimeter, or 0.5 to 2 millimeter.

All ranges disclosed herein are inclusive of the endpoints, and the endpoints are independently combinable with each other. “Combination” is inclusive of blends, mixtures, alloys, reaction products, and the like. The terms “a” and “an” and “the” herein do not denote a limitation of quantity, and are to be construed to cover both the singular and the plural, unless otherwise indicated herein or clearly contradicted by context. “Or” means “and/or.”

The term “alkyl” includes branched or straight chain, unsaturated aliphatic C₁₋₃₀ hydrocarbon groups e.g., methyl, ethyl, n-propyl, i-propyl, n-butyl, s-butyl, t-butyl, n-pentyl, s-pentyl, n- and s-hexyl, n- and s-heptyl, and, n- and s-octyl. “Alkenyl” means a straight or branched chain, monovalent hydrocarbon group having at least one carbon-carbon double bond (e.g., ethenyl (—HC═CH₂)). “Alkoxy” means an alkyl group that is linked via an oxygen (i.e., alkyl-O—), for example methoxy, ethoxy, and sec-butyloxy groups. “Alkylene” means a straight or branched chain, saturated, divalent aliphatic hydrocarbon group (e.g., methylene (—CH₂—) or, propylene (—(CH₂)₃—)). “Cycloalkylene” means a divalent cyclic alkylene group, —CₙH₂ₙ₋ₓ, wherein x represents the number of hydrogens replaced by cyclization(s). “Cycloalkenyl” means a monovalent group having one or more rings and one or more carbon-carbon double bonds in the ring, wherein all ring members are carbon (e.g., cyclopentyl and cyclohexyl). “Aryl” means an aromatic hydrocarbon group containing the specified number of carbon atoms, such as to phenyl, tropone, indanyl, or naphthyl. The prefix “halo” means a group or compound including one more of a fluoro, chloro, and bromo and iodo substituent or a combination thereof (e.g., bromo and fluoro). In an embodiment only chloro groups are present. The prefix “hetero” means that the compound or group includes at least one ring member that is a heteroatom (e.g., 1, 2, or 3 heteroatom(s)), wherein the heteroatom(s) is each independently N, O, S, or P. “Substituted” means that the compound or group is substituted with at least one (e.g., 1, 2, 3, or 4) substituents independently selected from, a C₁₋₉ alkoxy, a C₁₋₉ haloalkoxy, a nitro (—NO₂), a cyano (—CN), a C₁₋₆ alkyl sulfonyl (—S(═O)₂-alkyl), a C₆₋₁₂ aryl sulfonyl (—S(═O)₂-aryl)a thiol (—SH), a thiocyano (—SCN), a tosyl (CH₃C₆H₄SO₂—), a C₃₋₁₂ cycloalkyl, a C₂₋₁₂ alkenyl, a C₅₋₁₂ cycloalkenyl, a C₆₋₁₂ aryl, a C₇₋₁₃ arylalkylene, a C₄₋₁₂ heterocycloalkyl, and a C₃₋₁₂ heteroaryl instead of hydrogen, provided that the substituted atom's normal valence is not exceeded.

While particular embodiments have been described, alternatives, modifications, variations, improvements, and substantial equivalents that are or can be presently unforeseen can arise to applicants or others skilled in the art. Accordingly, the appended claims as filed and as they can be amended are intended to embrace all such alternatives, modifications variations, improvements, and substantial equivalents.

1. A reinforced polyetherimide composition, comprising
50 to 99.9 weight percent of a polymer composition comprising a polyetherimide having a weight average molecular weight of 5,000 to 80,000 Daltons;
10 to 40 weight percent of a reinforcing filler;
0.1 to 10 weight percent of flow promoter, wherein the flow promoter comprises an aromatic phosphate, a phosphazene, or a combination comprising at least one of the foregoing;
0 to 20 weight percent of a liquid crystalline polymer;
wherein weight percent is based on the total weight of the reinforced polyetherimide composition; and
wherein the reinforced polyetherimide composition has
a melt flow rate (MFR), measured according to ASTM D1238 (2015) at 337° C. under a 6.7 kgf load, that is at least 10% higher than that of the same reinforced polyetherimide composition without the flow promoter, and
a capillary melt viscosity, measured according to ASTM D3835 (2015) at a shear rate of 5000 l/s and a temperature of 380° C., that is at least 10% lower than that of the same reinforced polyetherimide composition without the flow promoter.

2. The reinforced polyetherimide composition of claim 1, wherein the flow promoter has a molecular weight from 500 to 1,200 Daltons.

3. The reinforced polyetherimide composition of claim 1, wherein the weight ratio of the flow promoter to the liquid crystalline polymer is 0.1:20 to 1:5.

4. The reinforced polyetherimide composition of claim 1, wherein the polyetherimide comprises units of the formula 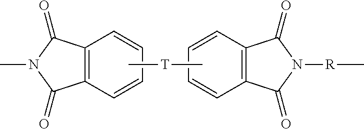
wherein
R is a C₂₋₂₀ hydrocarbon group,
T is —O— or a group of the formula —O—Z—O— wherein the divalent bonds of the —O— or the —O—Z—O— group are in the 3,3′, 3,4′, 4,3′, or the 4,4′ positions, and
Z is an aromatic C₆₋₂₄ monocyclic or polycyclic group optionally substituted with 1 to 6 C₁₋₈ alkyl groups, 1-8 halogen atoms, or a combination comprising at least one of the foregoing.

5. The reinforced polyetherimide composition of claim 4, wherein R is a divalent group of the formula 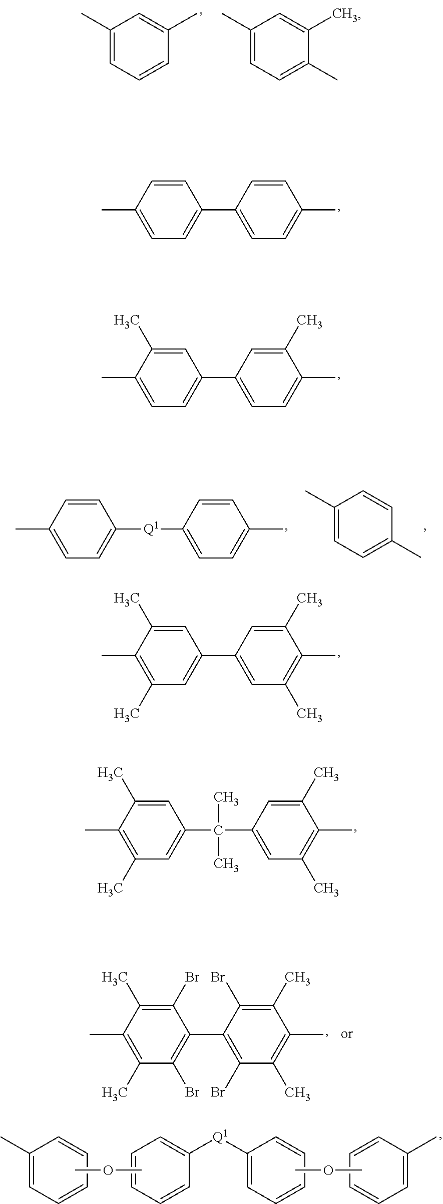
wherein
Q¹ is —O—, —S—, —C(O)—, —SO₂—, —SO—, —C_{y}H_{2y}— and a halogenated derivative comprising at least one of the foregoing wherein y is an integer from 1 to 5, or —(C₆H₁₀)_{z}— wherein z is an integer from 1 to 4; and Z is a group derived from a dihydroxy compound of the formula 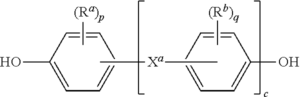
wherein
R^{a} and R^{b} are each independently a halogen atom or a monovalent C₁₋₆ alkyl group;
p and q are each independently integers of 0 to 4;
c is 0 to 4; and
X^{a} is a single bond, —O—, —S—, —SO₂—, —C(O)—, or a C₁₋₁₈ organic bridging group.

6. The reinforced polyetherimide composition of claim 4, wherein each R is independently meta-phenylene, para-phenylene, or a combination comprising at least one of the foregoing, and Z is 4,4′-diphenylene isopropylidene.

7. The reinforced polyetherimide composition of claim 1, wherein the polymer composition comprises 10 to 99 weight percent of the polyetherimide and 90 to 1 weight percent of a polymer different from the polyetherimide.

8. The reinforced polyetherimide composition of claim 7, wherein the polymer different from the polyetherimide comprises a polyamide, polyamideimide, polyarylene ether, polyarylene ether ketone, polyarylene sulfide, polyarylene sulfone, polycarbonate, polyester, polyimide, polyphenylenesulfone urea, polyphthalamide, self-reinforced polyphenylene, or a combination comprising at least one of the foregoing.

9. The reinforced polyetherimide composition of claim 1, wherein the reinforcing filler comprises glass fiber, carbon fiber, titanium dioxide, clay, talc, mica, silica, mineral filler, wollastonite, glass spheres, flaked glass, milled glass, carbon black, or a combination comprising at least one of the foregoing.

10. The reinforced polyetherimide composition of claim 1, wherein the flow promoter comprises an aromatic phosphate, and the aromatic phosphate is a bisphenol A diphosphate, resorcinol diphosphate, biphenol diphosphate, hydroquinone diphosphate, acetophenone bisphenol diphosphate, dihydroxy diphenyl ether diphosphate, or a combination comprising at least one of the foregoing.

11. The reinforced polyetherimide composition of claim 1, wherein the flow promoter comprises a phosphazene, and the phosphazene is poly(bis(phenoxy)phosphazene).

12. The reinforced polyetherimide composition of claim 1, wherein the flow promoter comprises an aryl phosphate and a phosphazene in a 1 to 1 weight ratio.

13. The reinforced polyetherimide composition of claim 1, wherein the reinforced polyetherimide composition comprises a liquid crystalline polymer, and the liquid crystalline polymer is a co-polyester, a co-polyesteramide, a multiple half or wholly aromatic polyester, or a combination comprising at least one of the foregoing.

14. The reinforced polyetherimide composition of claim 1, wherein the polyetherimide composition has a total average flame out time of less than or equal to 2.5 seconds, wherein the total average flame out time of the reinforced polyetherimide composition is less than the total average flame out time for the same reinforced polyetherimide composition with no added aryl phosphate or phosphazene, measured according to Underwriters Laboratory test bulletin UL94 using 1.5 millimeter samples.

15. The reinforced polyetherimide composition of claim 1, wherein the flow promoter is present in an amount ineffective to decrease flexural modulus measured according to ASTM D790, flexural strength measured according to ASTM D790, tensile modulus measured according to ASTM D648, coefficient of thermal expansion measured according to ISO 11359-2, or a combination comprising at least one of the foregoing, by more than 10%, compared to the same reinforced polyetherimide composition without the flow promoter.

16. An article comprising the reinforced polyimide of claim 1.

17. The article of claim 16, comprising a pressure molded, injection molded, or extruded article, preferably a molded article.

18. The article of claim 16, wherein the article is an electrical connector, an electrical socket, a circuit board, a circuit board component, a computer component, a display screen component, a communication device component, or a component of a hand-held electronic device.

19. The article of claim 16, wherein the article has a thickness of 0.01 to 2 millimeter.
